(19) United States
(12) Patent Application Publication
(10) Pub. No.: US 2002/0161458 A1
(43) Pub. Date: Oct. 31, 2002

(54) Service history log of computer repairs

(75) Inventors: George H. Ahrens, Pflugerville, TX (US); Leo C. Mooney, Cedar Park, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 09/843,064

(22) Filed: Apr. 26, 2001

(51) Int. Cl. G05B 11/01

(52) U.S. Cl. 700/21

(57) ABSTRACT

A system for implementing a method of monitoring service repairs of a processing system is disclosed. The system contacts a service representative in response to a reception of a data signal indicating an operational failure of the processing system. The contact includes a service action plan with a list of field replacement units that maybe the source of the operational failure. In response to one or more commands, the system displays a service action event log including the service action plan, and a service history log including any history of service repairs related to the service action plan. The service representative can partially or fully apply the service action plan to the repair, and subsequently flag the service action event entry as incomplete or closed, respectively.

### BACKGROUND OF THE INVENTION

1. Field of the Invention

The present invention generally relates to a service call for repairing a computer system. The present invention specifically relates to a utilization of a service history log in assisting varying service representatives with repairing a computer system.

2. Description of the Related Art

A service representative responding to a service call for repairing a computer system typically generates a repair record (e.g., parts replaced, components used, etc.) for storage within a corporate database. The repair record is intended to provide the original service representative or a different service representative with historical repair information of the computer system when the computer system experiences the same or similar type of problem. However, in many cases, the different service representative will not have access to the repair record when responding to a service call corresponding to the computer system experiencing the same or similar type of problem. As a result, the different service representative may duplicate the same repair action as the original service representative.

For example, a first service representative may respond to a service call for an intermittent problem indicating a processor card or a backplane as the possible field replacement unit serving as the source of a failure of the computer system. While the backplane is the true source of the failure, the first service representative may decide to replace the processor card, and runs a successful diagnostic verification of the computer system. Thus, the first service representative assumes that the processor card was the source of the failure and generates a first service repair record that is stored within a first database.

Shortly thereafter, a second service representative, from the same or different company, responds to a subsequent service call indicating the processor card and the backplane as the possible field replacement units serving as the source of a subsequent failure by the computer system. Without having access to the stored repair record, the second service representative decides to replace the processor card and runs a successful diagnostic verification of the computer system. As with the first service representative, the second service representative assumes that the processor card was the source of the failure and generates a second service repair record that is stored within the first database or a second database.

With the backplane being the true source of both failures and without a generation of a repair record that is accessible by all future service representatives responding to subsequent service call of the same type, then the processor card may be replaced again and again and again. What is therefore needed is a system and a method for facilitating a management of a repair history of a computer system by varying service representatives responding to various service calls for repairing the computer system.

### SUMMARY OF THE INVENTION

The present invention relates to a service history log of computer repairs that overcomes the disadvantages associated with the prior art. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a method for monitoring a service repair of a processing system. First, a data signal indicative of an operational failure of the processing system is received. Second, a plan for repairing the operational failure of the processing system is stored within a storage device in response to the reception of the data signal. Third, the plan for repairing the operational failure of the processing system stored within the storage device is retrieved during a repair of the operational failure of the processing system.

A second form of the present invention is a system for monitoring a service repair of a processing system. The system comprises a storage device. The system further comprises means for storing a plan for repairing an operational failure of the processing system within the storage device in response to a reception of a data signal indicative of the operational failure of the processing system, and means for retrieving the plan during a repair of the operational failure of the processing system.

A third form of the present invention is a computer program product in a computer readable medium for monitoring a service repair of the processing system. The computer program product comprises a computer readable code for storing a plan for repairing an operational failure of the processing system within the storage device in response to a reception of a data signal indicative of the operational failure of the processing system, and computer readable code for retrieving the plan from the storage device during a repair of the operational failure of the processing system.

The foregoing forms and other forms, features and advantages of the present invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram of one embodiment of computer hardware employed in the present invention;

FIG. 2 is a block diagram of one embodiment of computer software employed in the present invention; and

FIG. 3 is a flow chart of one embodiment in accordance with the present invention of a service call routine implemented by the FIG. 2 computer software.

### DETAILED DESCRIPTION OF THE PRESENTLY PREFERRED EMBODIMENTS

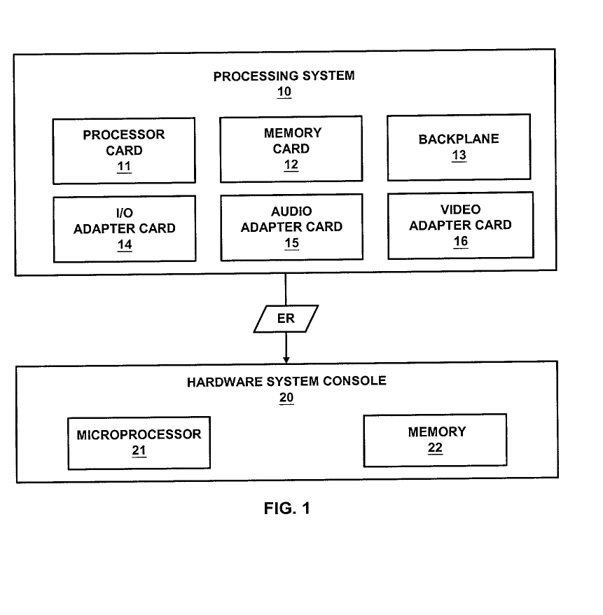

Referring to FIG. 1, a processing system 10 and a hardware system console 20 are shown. System 10 and console 20 may be configured in any form for accepting structured inputs, processing the inputs in accordance with prescribed rules, and outputting the processed results as would occur to those having ordinary skill in the art, such as, for example, a personal computer, a workstation, a super computer, a mainframe computer, a minicomputer, a super minicomputer, and a microcomputer.

For purposes of describing the principles of the present invention, system 10 is shown as comprising field replaceable units (FRUs) in the form of a processor card 11, a memory card 12, a backplane 13, an input/output (I/O) adapter card 14, an audio adapter card 15, and a video adapter card 16. System 10 runs an operating system, such as, for example, an AIX operating system or an OS/2 operating system, that provides an error report ER of any operational failure of system 10 to console 20. From the subsequent description herein of console 20, those having ordinary skill in the art will appreciate the applicability of the principles of the present invention to any embodiment of system 10, such as, for example, a logically partitioned LPAR multiprocessing system.

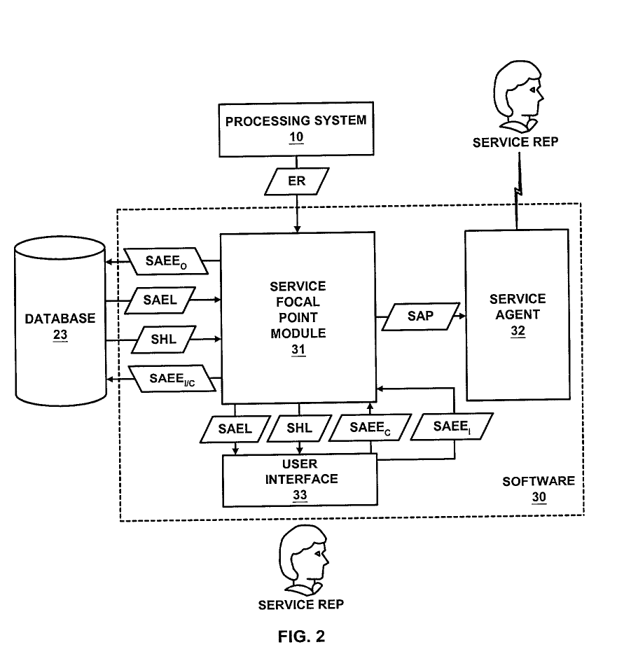

Console 20 comprises a microprocessor 21 and a memory 22. Microprocessor 21 is preferably one of the Intel families of microprocessors, one of the AMD families of microprocessors, one of the Motorola families of microprocessors, or one of the various versions of a Reduced Instruction Set Computer microprocessor such as the PowerPC chip manufactured by IBM. Memory 22 represents a single type of computer readable medium or an aggregate of various types of computer readable mediums for storing service software 30 (FIG. 2). Accordingly, memory 22 can include a read-only memory, a random access memory, a hard drive, a CD-ROM drive, a floppy drive, and/or the like. In other embodiments of console 20, software 30 may be partially or fully implemented with digital circuitry, analog circuitry, or both.

A database 23 (FIG. 2) is also stored within memory 22. Database 23 includes one or more service action event entries that are flagged as either an open item requiring a service call, an incomplete item that has partially serviced, or a complete item that has been fully serviced.

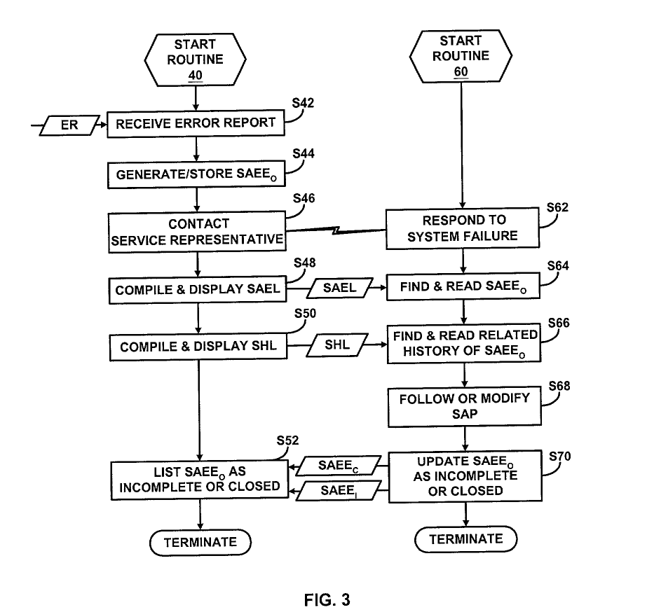

Referring additionally to FIG. 2, an interaction of software 30 with system 10, a service representative, and database 23 is shown. Software 30 includes a service focal point module 31, a service agent 32, and a user interface 33. A functional description of an implementation of a service call routine 40 (FIG. 3) by software 30 will now be described herein by the description of data transfers.

Referring additionally to FIG. 3, during a stage S42 of routine 40, module 31 receives error report ER from a diagnostic routine (not shown) or the like including in system 10 upon an operational failure of system 10. In one embodiment, error report ER includes a service action plan SAP that lists each FRU 11-16 of system 10 that may be the cause of the operational failure of system 10. The list is sorted from the most probable FRU for causing the operational failure to the least probable FRU for causing the operational failure. The sort most probable FRUs is based on one many possible techniques, such as: (1) type of failure; (2) types of FRUs in system; and (3) length of time between replacement and/or serving of certain FRUs.

Module 31 thereafter proceeds to a stage S44 of routine 40 to generate and store a service action event entry within database 23. In one embodiment, the service action event entry is stored as an open item SAEEₒ requiring a service call. The service action event entry SAEEₒ includes service action plan SAP and a flag indicating service action event entry SAEEₒ is an open item.

Module 31 thereafter proceeds to a stage S46 of routine 40 to contact a service representative. In one embodiment, module 31 provides service action plan SAP to service agent 32 whereby service agent 32 controls a call to the service representative.

In response thereto, the service representative can implement a routine 60 as shown. During a stage S62 of routine 60, the service representative reads the service action plan SAP whereby the service representative can ensure that he/she has the proper FRUs as well as sufficient equipment and tools for responding to the service call.

The service representative thereafter proceeds to a stage S64 of routine 60 to find service action event entry SAEEₒ on site. In one embodiment, the service representative utilizes a monitor (not shown) and a pointing device (not shown) of console 20 to access module 31 whereby module 31 sorts through database 23 to compile all open service action event entries within database 23 into a service action event log SAEL which is displayed via interface 33 on the monitor during a stage S48 of routine 40. The service action event log SAEL will include service action event entry SAEEₒ. The service representative can therefore search service action event log SAEL for service action event entry SAEEₒ to verify the need for the service call and review service action plan SAP.

The service representative thereafter proceeds to a stage S66 of routine 60 to ascertain the history of service action event entries related to service action event entry SAEEₒ. In one embodiment, the service representative utilizes the monitor and the pointing device of console 20 to access module 31 whereby module 31 sorts through database 23 to compile all incomplete and closed service action event entries within database 23 into a service history log SHL which is displayed via interface 33 on the monitor during a stage S50 of routine 40. In a second embodiment, module 31 automatically compiles and displays service history log SHL during stage S50 in response to compiling and displaying service action event log SAEL during stage S48.

The service history log SHL includes any incomplete or closed service action event entries related to service action event entry SAEEₒ. As such, the service representative searches service history log SHL for the incomplete and closed service action event entries related to service action event entry SAEEₒ. The related service action event entries will include associated service action plans as well as any comments provide by previous service representatives.

The service representative thereafter proceeds to a stage S68 of routine 60 to selectively apply the service action plan SAP of service action event entry SAEEₒ in view of the service actions plans and comments of the related service action event entries listed in service history log SHL. In one embodiment, the service representative replaces the FRU with the highest probability of being the cause of the operational failure of system 10 that does not have a repair history as indicted by service history log SHL. Thus, the service representative does not duplicate any previous service calls, yet more than likely resolves the cause of the operational failure of system 10.

Alternatively, when the service representative or an associated service center is of the opinion that a previous service call was not handled properly, the service representative can either (1) remove and then re-insert a FRU regardless of the repair history as indicted by service history log SHL or (2) replace a FRU that does have a repair history as indicted by service history log SHL.

The service representative thereafter proceeds to a stage S70 of routine 60 to access module 31 to thereby list service action event entry SAEEₒ as incomplete or closed within database 23 when partially or fully, respectively, implementing the service action plan SAP during stage S68. In one embodiment, user interface 33 provides a display of each FRU listed in the service action plan SAP whereby the service representative can mark each FRU that was replaced or re-inserted during the service repair. User interface 33 thereafter provides a display of a comment box whereby the service representative can provide details related to the service repair. A close service action event entry SAEE_{c} including any comments is provided to module 31 when the service representative marks one or more FRUs. Alternatively, an incomplete service action event entry SAEEᵢ including any comments is provided to module 31 when the service representative does not mark any FRUs.

In response thereto, during a stage S52 of routine 40, module 31 will store close service action event entry SAEE_{c} or incomplete service action event entry SAEEᵢ (whichever is received) within database 23. In one embodiment, module 31 stores close service action event entry SAEE_{c} or incomplete service action event entry SAEEᵢ by writing close service action event entry SAEE_{c} or incomplete service action event entry SAEEᵢ over open service action event entry SAEEₒ. In a second embodiment, module 31 changes a status flag of open service action event entry SAEEₒ to indicate open service action event entry SAEEₒ is incomplete or closed.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for monitoring multiple service repairs of an operational failure of the processing system, said method comprising the steps of:
receiving a first data signal indicative of the operational failure of the processing system;
storing a first plan for repairing the operational failure of the processing system within a storage device in response to the reception of the first data signal; and
retrieving the first plan from the storage device during a first service repair of the operational failure of the processing system.

2. The method of claim 1, further comprising:
storing the first plan within the storage device as closed after the first service repair of the operational failure of the processing system.

3. The method of claim 2, further comprising:
receiving a second data signal indicative of the operational failure of the processing system after a reception of the first data signal;
storing a second plan for repairing the operational failure of the processing system within the storage device in response to the reception of the second data signal; and
retrieving the first plan and the second plan from the storage device during a first service repair of the operational failure of the processing system.

4. The method of claim 1, further comprising:
storing the first plan within the storage device as incomplete after the first service repair of the operational failure of the processing system.

5. The method of claim 4, further comprising:
receiving a second data signal indicative of the operational failure of the processing system after a reception of the first data signal;
storing a second plan for repairing the operational failure of the processing system within the storage device in response to the reception of the second data signal; and
retrieving the first plan and the second plan from the storage device during a first service repair of the operational failure of the processing system.

6. A system for monitoring multiple service repairs of an operational failure of the processing system, said system comprising the steps of:
a storage device; and
a hardware system console including
means for receiving a first data signal indicative of the operational failure of the processing system,
means for storing a first plan for repairing the operational failure of the processing system within said storage device in response to the reception of the first data signal; and
means for retrieving the first plan from said storage device during a first service repair of the operational failure of the processing system.

7. The system of claim 6, wherein
said hardware system console further includes means for storing the first plan within said storage device as closed after the first service repair of the operational failure of the processing system.

8. The system of claim 7, wherein
said hardware system console further includes:
means for receiving a second data signal indicative of the operational failure of the processing system after a reception of the first data signal;
means for storing a second plan for repairing the operational failure of the processing system within said storage device in response to the reception of the second data signal; and
means for retrieving the first plan and the second plan from said storage device during a first service repair of the operational failure of the processing system.

9. The system of claim 6, wherein
said hardware system console further includes means for storing the first plan within said storage device as incomplete after the first service repair of the operational failure of the processing system.

10. The system of claim 9, wherein
said hardware system console further includes:
means for receiving a second data signal indicative of the operational failure of the processing system after a reception of the first data signal;
means for storing a second plan for repairing the operational failure of the processing system within said storage device in response to the reception of the second data signal; and
means for retrieving the first plan and the second plan from said storage device during a first service repair of the operational failure of the processing system.

11. A computer program product in a computer readable medium for monitoring multiple service repairs of an operational failure of the processing system, said computer program product comprising:
computer readable code for receiving a first data signal indicative of an operational failure of the processing system;
computer readable code for storing a first plan for repairing the operational failure of the processing system within a storage device in response to the reception of the first data signal; and
computer readable code for retrieving the first plan from the storage device during a first service repair of the operational failure of the processing system.

12. The computer program product of claim 11, further comprising:
computer readable code for storing the first plan within the storage device as closed after the first service repair of the operational failure of the processing system.

13. The computer program product of claim 12, further comprising:
computer readable code for receiving a second data signal indicative of the operational failure of the processing system after a reception of the first data signal;
computer readable code for storing a second plan for repairing the operational failure of the processing system within the storage device in response to the reception of the second data signal; and
computer readable code for retrieving the first plan and the second plan from the storage device during a first service repair of the operational failure of the processing system.

14. The computer program product of claim 11, further comprising:
computer readable code for storing the first plan within the storage device as incomplete after the first service repair of the operational failure of the processing system.

15. The computer program product of claim 14, further comprising:
computer readable code for receiving a second data signal indicative of the operational failure of the processing system after a reception of the first data signal;
computer readable code for storing a second plan for repairing the operational failure of the processing system within the storage device in response to the reception of the second data signal; and
computer readable code for retrieving the first plan and the second plan from the storage device during a first service repair of the operational failure of the processing system.

16. A method for monitoring a service repair of an operational failure of a processing system, said method comprising the steps of:
searching a storage device to identify each service plan related to the operational failure of the processing system during the service repair of the operational failure of the processing system; and
facilitating a display of each service plan identified as being related to the operational failure of the processing system during the service repair of the operational failure of the processing system.

17. A system for monitoring a service repair of an operational failure of a processing system, said system comprising:
a storage device; and
a hardware system console including
means for searching said storage device to identify each service plan related to the operational failure of the processing system during the service repair of the operational failure of the processing system; and
means for facilitating a display of each service plan identified as being related to the operational failure of the processing system during the service repair of the operational failure of the processing system.

18. A computer program product in a computer readable medium for monitoring a service repair of an operational failure of a processing system, said computer program product comprising the steps of:
computer readable code for searching a storage device to identify each service plan related to the operational failure of the processing system during the service repair of the operational failure of the processing system; and
computer readable code for facilitating a display of each service plan identified as being related to the operational failure of the processing system during the service repair of the operational failure of the processing system.
